(19) United States
(12) Patent Application Publication
(10) Pub. No.: US 2024/0220781 A1
(43) Pub. Date: Jul. 4, 2024

(54) Differentially-private Neural Networks Using Architecture Search

(71) Applicant: Oracle International Corporation, Redwood City, CA (US)

(72) Inventor: Daniel Wyde Peterson, Laramie, WY (US)

(21) Appl. No.: 18/150,147

(22) Filed: Jan. 4, 2023

(51) Int. Cl. G06N 3/047; G06N 3/084

(52) U.S. Cl. CPC G06N 3/047; G06N 3/084

(57) ABSTRACT

Systems, computer instruction encoded on non-transitory computer-accessible storage media and computer-implemented methods are disclosed for determining differentially-private neural network architectures. Training data suitable to determine a neural network architecture may be obtained and a subset of the neural network including randomly-initialized weighting parameters may be selected. Score values for individual ones of the weighting parameters may be computed including noise values added to the computed scores to produce differentially-private scores. A portion of the weighting values with the highest differentially-private scores may be selected to form a neural subnetwork of the neural network that may function as differentially-private neural network architecture for the training data.

### BACKGROUND

### Field of the Disclosure

This disclosure relates generally to computer hardware and software, and more particularly to systems and methods for implementing machine learning systems.

### Description of the Related Art

Differential privacy is often required for public release of large models trained on sensitive data. Traditional approaches to providing differential privacy in machine learning models involve adding noise to a classical network training process such as Differentially-Private Stochastic Gradient Descent (DP_SGD). These approaches, however, may significantly degrade model accuracy, even when using the current state-of-the-art training algorithms and modest privacy guarantees.

### SUMMARY

Methods, techniques and systems for determining differentially-private neural network architectures are disclosed. Training data suitable to determine a neural network architecture may be obtained and a subset of a neural network including randomly-initialized weighting parameters may be selected. Score values for individual ones of the weighting parameters may be computed including noise values added to the computed scores to produce differentially-private scores. A portion of the weighting values with the highest differentially-private scores may be selected to form a neural subnetwork of the neural network that may function as differentially-private neural network architecture for the training data.

### BRIEF DESCRIPTION OF THE DRAWINGS

FIG. 1 is a block diagram illustrating a machine learning system which provides differentially-private machine learning models using neural architecture search, in various embodiments.

FIG. 2 is a block diagram illustrating training using a sampled training dataset of a differentially-private machine learning model using neural architecture search, in various embodiments.

FIG. 3 is a block diagram illustrating training iterations of a differentially-private machine learning model using neural architecture search, in various embodiments.

FIG. 4 is a flow diagram illustrating a machine learning system which provides differentially-private machine learning models using neural architecture search with differential privacy provided in the determination of probability scores, in various embodiments.

FIG. 5 is a flow diagram illustrating a machine learning system which provides differentially-private machine learning models using neural architecture search and differentially private stochastic gradient descent, in various embodiments.

FIG. 6 is a flow diagram illustrating a machine learning system which provides differentially-private machine learning models using neural architecture search with differential privacy provided in the determination of probability scores and using differentially private stochastic gradient descent, in various embodiments.

FIG. 7 is a block diagram illustrating one embodiment of a computing system that is configured to implement position-independent addressing modes, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Differential Privacy (DP) provides a theoretical guarantee of privacy that can be applied to machine learning (ML) models. By adding carefully calibrated noise to the results of various computations, DP weakens potential attacks that may try to uncover data, or sources of data, from a trained algorithm. This is extremely attractive for training ML models on personal data about individuals because it affords everyone a measure of privacy.

Differential privacy is often required for public release of large machine learning models trained on sensitive data. Traditional approaches to providing differential privacy in machine learning models, however, involve adding noise to the training process which may severely degrade model accuracy, even when using the current state-of-the-art algorithms.

One reason for this degradation is that the added noise may cause a large impact to training because it is calibrated to the sensitivity of gradients to the data points, which is based on the magnitude of the change the gradients may experience as a result of a single, adversarially-chosen, data point The sensitivity may be bounded by enforcing a per-example maximum gradient magnitude which results in a dramatic loss in efficiency of the backward pass where clipping of gradients per-example cannot be batched. Once the gradients are clipped, the batch gradient is no longer an unbiased estimator of the true gradient, and noise proportional to the clipping magnitude must further be added.

Noise increases the variance of the estimated gradient, the clipping threshold introduces bias and the bias-variance tradeoffs are hard to manage and difficult to tune. All this is compounded with a severe loss of computational efficiency through processing individual data points in batches.

To overcome these various limitations, machine learning models may provide differential privacy by instead training the model using neural architecture subnetwork search over a randomly-initialized network, in various embodiments. Several techniques implementing neural architecture search exist but do not see much practical use on real problems and are instead positioned as ways to better understand the training of neural networks. This is because neural architecture search typically suffers from slight decreases in utility compared to other training methods.

Under differential privacy constraints, however, neural architecture search provides several advantages. First, the initialized weights of the neural network are never modified. Instead, selected weights are simply removed such that an attacker receives much less information about the training data. Second, noise calibration is much simpler. Where classical network training, such as Differentially-Private Stochastic Gradient Descent (DP_SGD), may achieve only 85.70% accuracy at an (ε=2.69, Δ=1e-6) privacy level, not a strong privacy guarantee, neural architecture search may provide an 87.07% accuracy.

Privacy leakage is often tied to memorization of training examples and overfitting. If weights are not tuned after initialization, accuracy may be reduced but the model's ability to fine-tune its margins around individual training examples is constrained. Also, neural architecture search is essentially a search over “mask” functions that remove weights from the network. This mask is binary and so reveals only one bit of information about each weight in the network. On the other hand, learned weights will tend to have a small percentage of high-magnitude weights that may help characterize the training data. This is a function of model memorization where the model attempts to produce high-confidence classifications on data in the training set, and larger weights help make sharper decision boundaries.

Neural architecture search may be used to enforce DP in two ways: first, a set of per-weight scores may be learned using Differentially-Private Stochastic Gradient Descent (DP-SGD) and second, the sub-network may be selected from the scores using a differentially-private selection algorithm. In both these enforcement mechanisms, differentially-private architecture search may be more feasible than learning network weights using DP-SGD. Because the weight matrices are fixed, the gradients from each example have a natural bound in magnitude, the errors backpropagate from the loss function for an example, and at each layer are multiplied by a magnitude-bounded (because it is fixed) weights matrix. With initialization selected so that the weight matrices have unity magnitude, using activation functions with bounded gradients (e.g. the commonly-used Tan H or ReLU nonlinearities), the per-example gradients for a given layer can never grow beyond a pre-computed value and the sensitivity of gradient updates is straightforward to calculate from the magnitude of the loss function on each example. When using DP-SGD, this allows avoidance of costly per-example gradient clipping and may work with batched computation.

In contrast to traditional training approaches that attempt to optimize a neural network's weights using gradient descent, then add differential privacy, a search is performed to identify a subnetwork that minimizes loss without changing randomly-initialized weights. This subnetwork will effectively replace weighting values for a majority of the randomly-initialized network weights with zero, thus dropping connections between neurons and keeping only the connections that were, by happenstance, already able to perform the desired function. Such a subnetwork is extremely likely to exist in a sufficiently large neural network and, in practice, many of the neural network parameters will be driven to zero by the collection of regularizers used in training.

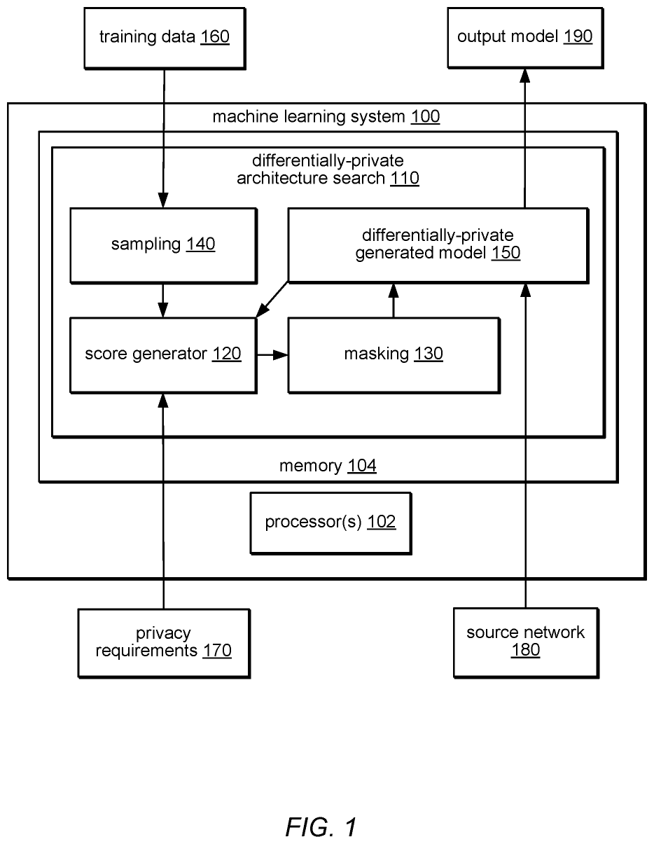

FIG. 1 is a block diagram illustrating a machine learning system which may provide a differentially-private machine learning model using neural architecture search, in various embodiments. A machine learning system 100 may include a processor 102 and memory 104 to implement differentially-private architecture search 110. Differentially-private architecture search 110 may use training data 160 to generate an output machine learning model 190. To generate the output machine learning model 190, the machine learning system 100 may first initialize a neural network (not shown) with a plurality of randomly valued weighting parameters. In some embodiments, these weighting parameters, although randomly valued, may collectively comply with certain constraints. For example, the collective weighting parameters may form a weighting matrix of a collective unity magnitude to facilitate simpler computation during subsequent training and score determination. Alternatively, a source network 180 with known characteristics may be obtained rather than initialized. Through a number of training cycles, the initialized neural network may be refined to generate a differentially-private model 150 that, upon completion of training, may be provided as the output model 190, in some embodiments.

To perform a training cycle, sampling 140 of the training data 160 may be performed to generate a training dataset provided to a score generator 120. The score generator 120 may use this training dataset along with an input model 150 to compute various probability scores for respective weighting factors in the input model, in some embodiments. These weighting values may then be used as input to a determination of a masking 130 operation that selects a subnetwork of the input network. This selected subnetwork then becomes the differentially-private generated model 150 that is used both to generate updated probability scores and as input to a next training cycle, in some embodiments. To generate updated probability scores, a Stochastic Gradient Descent (SGD) technique may be used to estimate loss, or error, between the selected subnetwork according to the training dataset for the training cycle. It should be understood, however, that the use of SGD in the estimation of loss or error is merely an example and any number of techniques for estimating loss or error may be envisioned. The differentially-private architecture search 110 may then execute training cycles iteratively with additional samplings of the training data 160 until a desired output model 190 is generated.

The computation of probability scores may involve the addition of noise for individual ones of the scores to generate noisy weighting parameter probability scores. A noise generator may consider privacy requirements 170, a manner in which the weighting parameters were initialized, the collective values of the various scores, and so forth. These examples are not intended to be limiting and various means of generating these noise values may be envisioned. A subset of the noisy probability parameters that include the highest noisy scores may be selected to create a neural subnetwork of the initialized neural network providing differential. Weighting parameters not selected may have their weighting parameters set to a zero, in some embodiments. The machine learning controller 106 may generate a trained machine learning model 130 that includes the selected neural subnetwork.

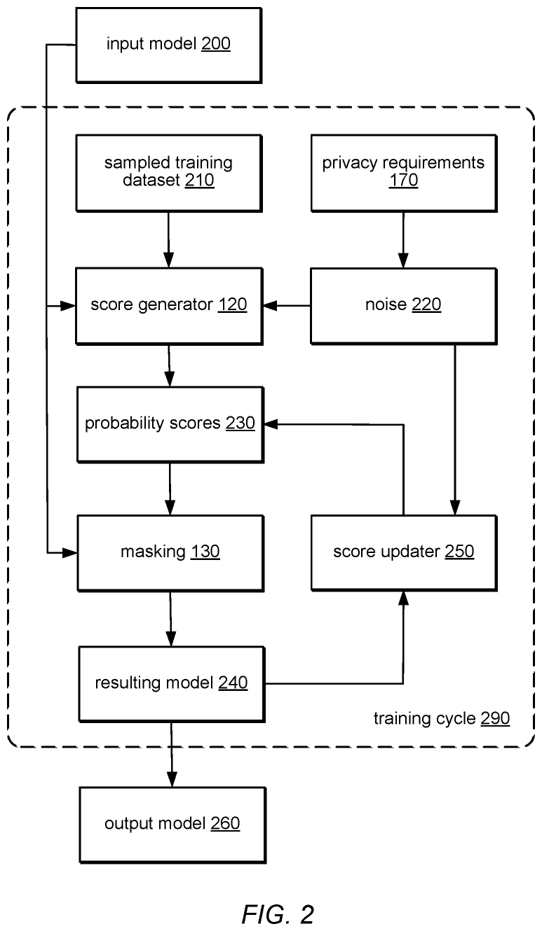

FIG. 2 is a block diagram illustrating a single cycle of training of a differentially-private machine learning model using neural architecture search, in various embodiments. A score generator 120 may receive a sampled training dataset 210, such as from sampling 140 the training data 140 as shown in FIG. 1, and an input model 200, such as the differentially-private generated model 150 or source network 180 as shown in FIG. 1, in some embodiments. The input model 200 may include multiple layers each including multiple nodes, where nodes in consecutive layers may be interconnected using weighting factors, in some embodiments. In addition, the input model may include a mask which enables only certain weighting factors and disables other weighting factors within the input model, effectively selecting a subnetwork of a total neural network within the model.

The score generator 120 may generate probability scores 230 for respective ones of the weighting factors of the neural network of the input model 200, in some embodiments. These scores may be generated using a forward propagation technique using only weighting values that are enabled as part of a selected subnetwork of the input model 200, where some portion of the weighting values of the neural network are excluded from the forward propagation calculation. In some embodiments, noise 220 may be added to these probability scores computed using the forward propagation technique, where the noise 220 may be generated according to privacy requirements 170, a manner in which the weighting parameters were initialized, the collective values of the various scores, and so forth.

The generated probability scores 230 may then be used to determine a masking operation 130, where weighting values with highest scores are enabled or included in a selected subnetwork of the neural network of the ML model while weighting values with lowest scores are disabled or excluded from the selected subnetwork of the neural network of the ML model, in some embodiments. In some embodiments, a fixed proportion of highest-scored weighting values of individual ones of multiple layers of the neural network may be enabled, with the same or different fixed proportions being used for different layers of the network. In other embodiments, individual layers of the neural network may have dynamically selected proportions of enabled weighting values based at least in part on a minimum accuracy threshold. These examples are not intended to be limiting, however, and proportions of enabled weighting values may be determined in a variety of ways in various embodiments.

By applying the masking 130, a resulting model 240, such as the differentially-private generated model 150 of FIG. 1, may be generated that includes a newly selected subnetwork of the neural network of the input model 200. If the newly selected subnetwork is consistent with the subnetwork used in the forward propagation computation of the score generator 120, the resulting model 240 may be used as the output model 260. If the newly selected subnetwork is different from the subnetwork used in the forward propagation computation of the score generator 120, then the probability scores 230 may be updated by a score updater 250 using a backward propagation technique that includes all weighting factors of the neural network, including weighting factors both included and excluded from the selected subnetwork, in some embodiments. This backward propagation may be implemented using a Stochastic Gradient Descent (SGD) technique, and the SGD technique, may in some embodiments further employ Differential Privacy (DP) guarantees through the use of noise 220 generated according to privacy requirements 170, a manner in which the weighting parameters were initialized, the collective values of the various scores, and so forth. The process may then iterate according to the SGD technique until the output model 260 is realized, in some embodiments.

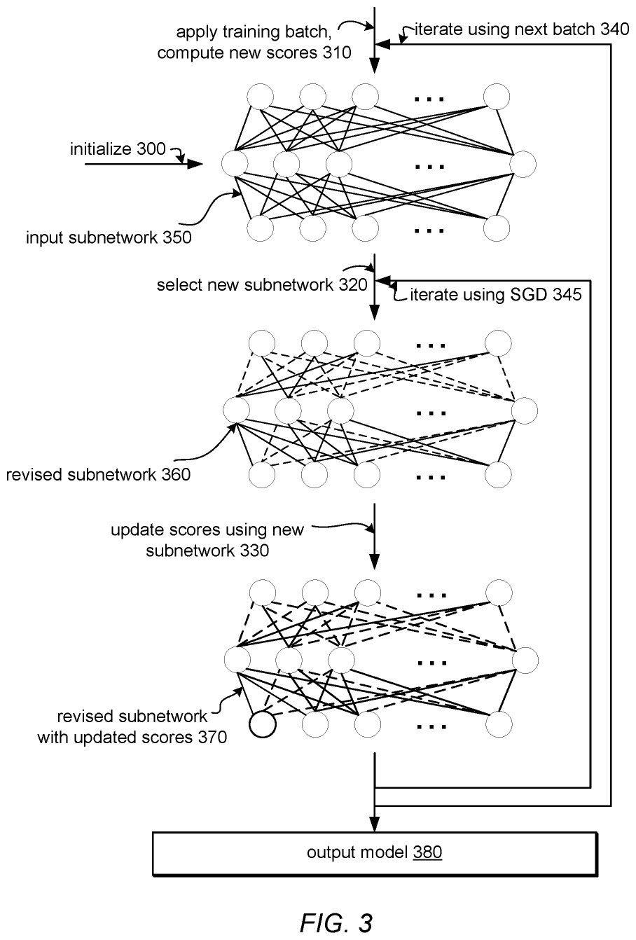

FIG. 3 is a block diagram illustrating training iterations of a differentially-private machine learning model using neural architecture search, in various embodiments. A neural network may be initialized 300, where the neural network, such as the source network 180 of FIG. 1, may include multiple layers each including multiple nodes, with respective nodes in consecutive layers be interconnected using weighting factors, in some embodiments. Network layers in FIG. 3 are depicted vertically with individual node depicted using circles arranged horizontally. In addition, the neural network may include a mask which enables only certain weighting factors and disables other weighting factors within the input model, effectively selecting an input subnetwork 350 of a total neural network. Active interconnections between nodes of the subnetwork are depicted as solid lines while inactive, disabled, or excluded interconnections are shown as dotted lines between nodes.

A given training cycle, batch or mini-batch 310, such as sampled training dataset 210 as shown in FIG. 2, may be applied to train the network, in some embodiments. This training dataset will be applied, such as by the score generator 120 of FIG. 2, using forward propagation to generate probability scores, as discussed above in FIG. 2. Then, a new subnetwork may be selected 320 using the generated probability scores, where weighting values with highest probability scores are enabled or included in a selected subnetwork of the neural network while weighting values with lowest probability scores are disabled or excluded from the selected subnetwork of the neural network, in some embodiments. In some embodiments, a fixed proportion of highest-scored weighting values of individual ones of multiple layers of the neural network may be enabled, with the same or different fixed proportions being used for different layers of the network. In other embodiments, individual layers of the neural network may have dynamically selected proportions of enabled weighting values based at least in part on a minimum accuracy threshold. These examples are not intended to be limiting, however, and proportions of enabled weighting values may be determined in a variety of ways in various embodiments. This selection may then result in a revised subnetwork 360, such as the differentially-private generated model 150 of FIG. 1, in some embodiments.

If the revised subnetwork is different from the subnetwork used in the forward propagation computation, then the probability scores may be updated 330, such as by the score updater 250 of FIG. 2, using a backward propagation technique that includes all weighting factors of the neural network, including weighting factors both included and excluded from the selected subnetwork, in some embodiments. This backward propagation may be implemented using a Stochastic Gradient Descent (SGD) technique, and the SGD technique, may in some embodiments further employ Differential Privacy (DP) guarantees through the use of noise 220 generated according to privacy requirements 170, a manner in which the weighting parameters were initialized, the collective values of the various scores, and so forth. The process may then iterate according to the SGD technique 345 until a stable subnetwork is realized, in some embodiments. Once a stable subnetwork is realized, the process may then iterate according to a next training cycle, batch or mini-batch 340. Upon completion of all training cycles, an output model 380 may be provided, in some embodiments.

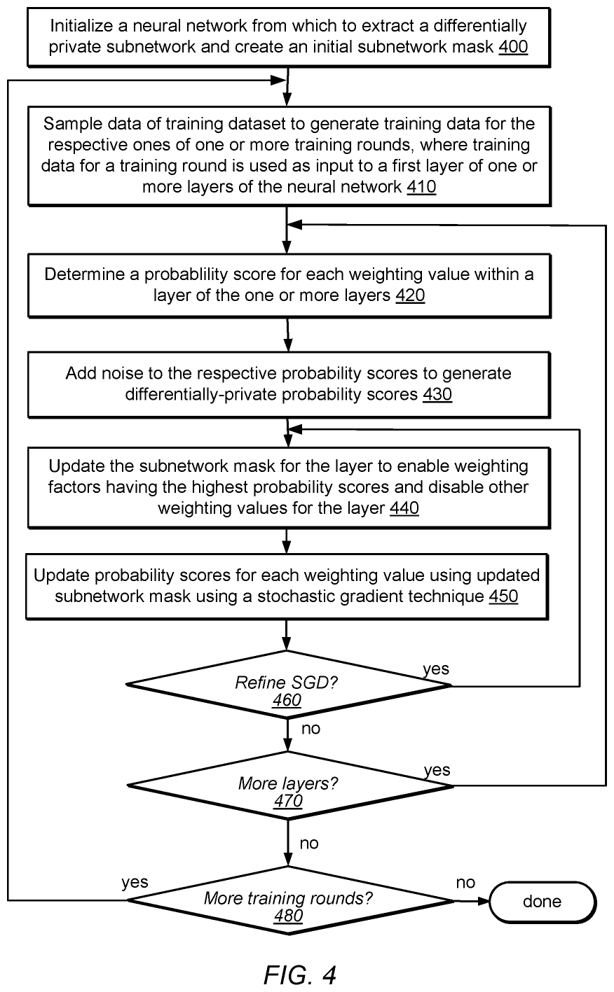

FIG. 4 is a flow diagram illustrating a machine learning system which provides differentially-private machine learning models using neural architecture search with differential privacy provided in the determination of probability scores, in various embodiments.

The process begins at step 400 where a machine learning system, such as the machine learning system 110 as shown in FIG. 1, may first initialize a neural network, such as the source network 180 of FIG. 1, with a plurality of randomly valued weighting parameters, in some embodiments, to generate an initial generated model, such as the differentially-private generated model 150 of FIG. 1. In some embodiments, these weighting parameters, although randomly valued, may collectively comply with certain constraints. For example, the collective weighting parameters may form a weighting matrix whose magnitude is one to facilitate simpler computation during subsequent training and score determination.

As shown in 410, training data may then be sampled to generate a training dataset, batch or mini-batch, in some embodiments, such as the sampled training dataset 210 as shown in FIG. 2. This sampled data may be used as input to a first layer of the neural network, in various embodiments.

As shown in 420, probability scores, such as the probability scores 230 of FIG. 2, may be generated for respective ones of the weighting factors for a layer of the neural network, in some embodiments. These scores may be generated using a forward propagation technique using only weighting values that are enabled as part of a current subnetwork of the neural network, where some portion of the weighting values of the neural network are excluded from the forward propagation calculation.

As shown in 430, in some embodiments noise, such as noise 220 as shown in FIG. 2, may be added to the generated probability scores computed using the forward propagation technique, where the noise may be generated according to privacy requirements, a manner in which the weighting parameters were initialized, the collective values of the various scores, and so forth. This added noise may then generate differentially-private probability scores for the various weighting factors, in some embodiments.

As shown in 440, the generated differentially-private probability scores may then be used to determine a subnetwork mask for a masking operation, such as masking 130 as shown in FIG. 1, where weighting values with highest scores are enabled or included in a selected subnetwork of the neural network of the ML model while weighting values with lowest scores are disabled or excluded from the selected subnetwork of the neural network of the ML model, in some embodiments. In some embodiments, a fixed proportion of highest-scored weighting values of individual ones of multiple layers of the neural network may be enabled, with the same or different fixed proportions being used for different layers of the network. In other embodiments, individual layers of the neural network may have dynamically selected proportions of enabled weighting values based at least in part on a minimum accuracy threshold. These examples are not intended to be limiting, however, and proportions of enabled weighting values may be determined in a variety of ways in various embodiments. By applying the determined subnetwork mask, a resulting model, such as the differentially-private generated model 150 of FIG. 1, may be generated that includes a newly selected subnetwork.

As shown in 450, the probability scores may then be updated using a backward propagation technique that includes all weighting factors of the neural network, including weighting factors both included and excluded from the selected subnetwork, in some embodiments. This backward propagation may be implemented using a Stochastic Gradient Descent (SGD) technique. If the newly selected subnetwork is consistent with the subnetwork used in the forward propagation computation, such as indicated by the negative exit from 460, then the process may proceed to step 470. If the newly selected subnetwork is different from the subnetwork used in the forward propagation computation, such as indicated by the positive exit from 460, then the process may return to step 440, in some embodiments.

As shown in step 470, it may then be determined if additional layers of the model need to be processed. If more layers remain, as indicated in a positive exit from 470, then the process may return to step 420. If no more layers remain, as indicated in a negative exit from 470, then the process may continue to step 480.

As shown in step 480, it may then be determined if additional training rounds need to be processed. If more training rounds remain, as indicated in a positive exit from 480, then the process may return to step 410. If no more training rounds remain, as indicated in a negative exit from 480, then the process is complete.

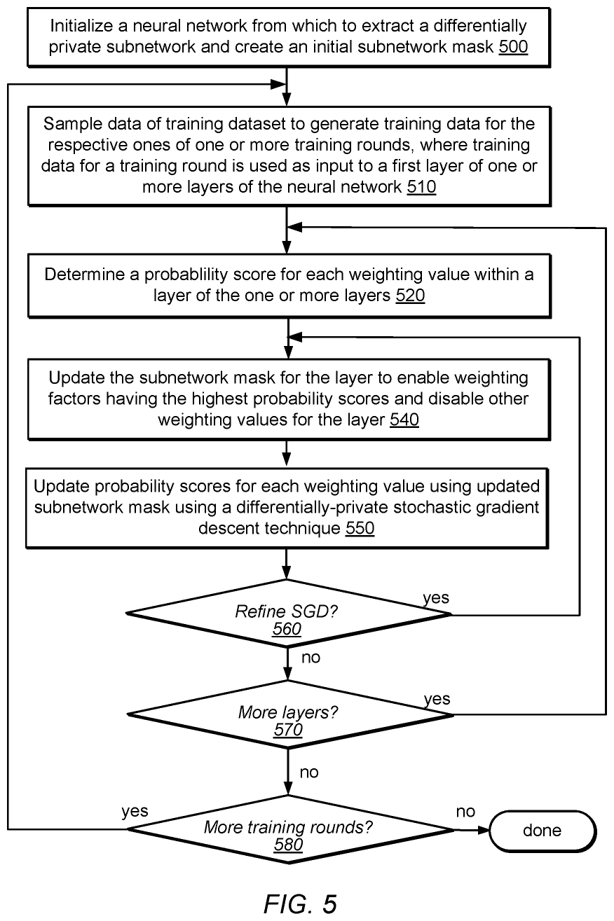

FIG. 5 is a flow diagram illustrating a machine learning system which provides differentially-private machine learning models using neural architecture search and differentially private stochastic gradient descent, in various embodiments.

The process begins at step 500 where a machine learning system, such as the machine learning system 110 as shown in FIG. 1, may first initialize a neural network, such as the source network 180 of FIG. 1, with a plurality of randomly valued weighting parameters, in some embodiments, to generate an initial generated model, such as the differentially-private generated model 150 of FIG. 1. In some embodiments, these weighting parameters, although randomly valued, may collectively comply with certain constraints. For example, the collective weighting parameters may form a weighting matrix whose magnitude is one to facilitate simpler computation during subsequent training and score determination.

As shown in 510, training data may then be sampled to generate a training dataset, batch or mini-batch, in some embodiments, such as the sampled training dataset 210 as shown in FIG. 2. This sampled data may be used as input to a first layer of the neural network, in various embodiments.

As shown in 520, probability scores, such as the probability scores 230 of FIG. 2, may be generated for respective ones of the weighting factors for a layer of the neural network, in some embodiments. These scores may be generated using a forward propagation technique using only weighting values that are enabled as part of a current subnetwork of the neural network, where some portion of the weighting values of the neural network are excluded from the forward propagation calculation.

As shown in 540, the generated differentially-private probability scores may then be used to determine a subnetwork mask for a masking operation, such as masking 130 as shown in FIG. 1, where weighting values with highest scores are enabled or included in a selected subnetwork of the neural network of the ML model while weighting values with lowest scores are disabled or excluded from the selected subnetwork of the neural network of the ML model, in some embodiments. In some embodiments, a fixed proportion of highest-scored weighting values of individual ones of multiple layers of the neural network may be enabled, with the same or different fixed proportions being used for different layers of the network. In other embodiments, individual layers of the neural network may have dynamically selected proportions of enabled weighting values based at least in part on a minimum accuracy threshold. These examples are not intended to be limiting, however, and proportions of enabled weighting values may be determined in a variety of ways in various embodiments. By applying the determined subnetwork mask, a resulting model, such as the differentially-private generated model 150 of FIG. 1, may be generated that includes a newly selected subnetwork.

As shown in 550, the probability scores may then be updated using a backward propagation technique that includes all weighting factors of the neural network, including weighting factors both included and excluded from the selected subnetwork, in some embodiments. This backward propagation may be implemented using a Differentially-Private Stochastic Gradient Descent (DP-SGD) technique using noise generated according to privacy requirements, a manner in which the weighting parameters were initialized, the collective values of the various scores, and so forth. If the newly selected subnetwork is consistent with the subnetwork used in the forward propagation computation, such as indicated by the negative exit from 560, then the process may proceed to step 570. If the newly selected subnetwork is different from the subnetwork used in the forward propagation computation, such as indicated by the positive exit from 560, then the process may return to step 540, in some embodiments.

As shown in step 570, it may then be determined if additional layers of the model need to be processed. If more layers remain, as indicated in a positive exit from 570, then the process may return to step 520. If no more layers remain, as indicated in a negative exit from 570, then the process may continue to step 580.

As shown in step 580, it may then be determined if additional training rounds need to be processed. If more training rounds remain, as indicated in a positive exit from 580, then the process may return to step 510. If no more training rounds remain, as indicated in a negative exit from 580, then the process is complete.

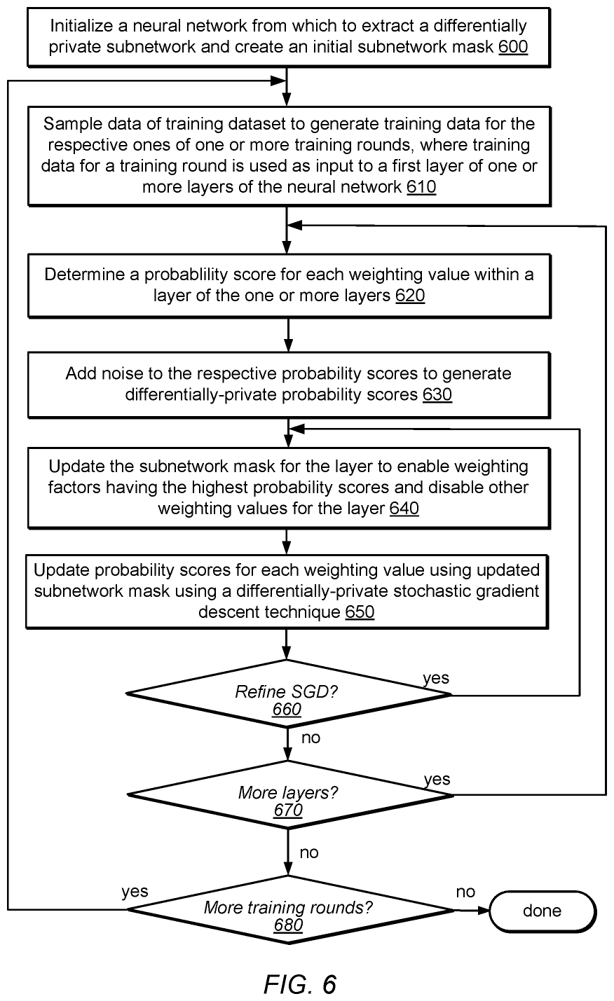

FIG. 6 is a flow diagram illustrating a machine learning system which provides differentially-private machine learning models using neural architecture search with differential privacy provided in the determination of probability scores and using differentially private stochastic gradient descent, in various embodiments.

The process begins at step 600 where a machine learning system, such as the machine learning system 110 as shown in FIG. 1, may first initialize a neural network, such as the source network 180 of FIG. 1, with a plurality of randomly valued weighting parameters, in some embodiments, to generate an initial generated model, such as the differentially-private generated model 150 of FIG. 1. In some embodiments, these weighting parameters, although randomly valued, may collectively comply with certain constraints. For example, the collective weighting parameters may form a weighting matrix whose magnitude is one to facilitate simpler computation during subsequent training and score determination.

As shown in 610, training data may then be sampled to generate a training dataset, batch or mini-batch, in some embodiments, such as the sampled training dataset 210 as shown in FIG. 2. This sampled data may be used as input to a first layer of the neural network, in various embodiments.

As shown in 620, probability scores, such as the probability scores 230 of FIG. 2, may be generated for respective ones of the weighting factors for a layer of the neural network, in some embodiments. These scores may be generated using a forward propagation technique using only weighting values that are enabled as part of a current subnetwork of the neural network, where some portion of the weighting values of the neural network are excluded from the forward propagation calculation.

As shown in 630, in some embodiments noise, such as noise 220 as shown in FIG. 2, may be added to the generated probability scores computed using the forward propagation technique, where the noise may be generated according to privacy requirements, a manner in which the weighting parameters were initialized, the collective values of the various scores, and so forth. This added noise may then generate differentially-private probability scores for the various weighting factors, in some embodiments.

As shown in 640, the generated differentially-private probability scores may then be used to determine a subnetwork mask for a masking operation, such as masking 130 as shown in FIG. 1, where weighting values with highest scores are enabled or included in a selected subnetwork of the neural network of the ML model while weighting values with lowest scores are disabled or excluded from the selected subnetwork of the neural network of the ML model, in some embodiments. In some embodiments, a fixed proportion of highest-scored weighting values of individual ones of multiple layers of the neural network may be enabled, with the same or different fixed proportions being used for different layers of the network. In other embodiments, individual layers of the neural network may have dynamically selected proportions of enabled weighting values based at least in part on a minimum accuracy threshold. These examples are not intended to be limiting, however, and proportions of enabled weighting values may be determined in a variety of ways in various embodiments. By applying the determined subnetwork mask, a resulting model, such as the differentially-private generated model 150 of FIG. 1, may be generated that includes a newly selected subnetwork.

As shown in 650, the probability scores may then be updated using a backward propagation technique that includes all weighting factors of the neural network, including weighting factors both included and excluded from the selected subnetwork, in some embodiments. This backward propagation may be implemented using a Differentially-Private Stochastic Gradient Descent (DP-SGD) technique using noise generated according to privacy requirements, a manner in which the weighting parameters were initialized, the collective values of the various scores, and so forth. If the newly selected subnetwork is consistent with the subnetwork used in the forward propagation computation, such as indicated by the negative exit from 660, then the process may proceed to step 670. If the newly selected subnetwork is different from the subnetwork used in the forward propagation computation, such as indicated by the positive exit from 660, then the process may return to step 640, in some embodiments.

As shown in step 670, it may then be determined if additional layers of the model need to be processed. If more layers remain, as indicated in a positive exit from 670, then the process may return to step 620. If no more layers remain, as indicated in a negative exit from 670, then the process may continue to step 680.

As shown in step 680, it may then be determined if additional training rounds need to be processed. If more training rounds remain, as indicated in a positive exit from 680, then the process may return to step 610. If no more training rounds remain, as indicated in a negative exit from 680, then the process is complete.

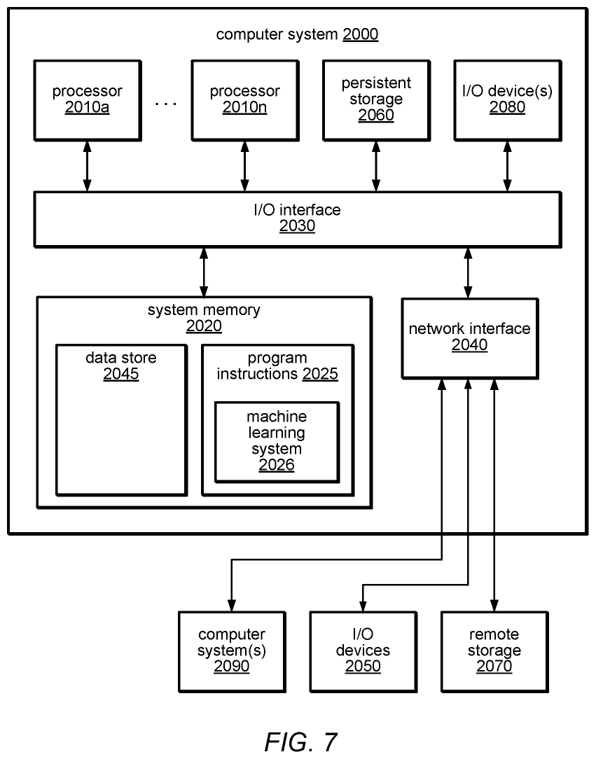

Any of various computer systems may be configured to implement processes associated with a technique for multi-region, multi-primary data store replication as discussed with regard to the various figures above. FIG. 7 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 7 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above providing a machine learning system as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 7 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

Program instructions 2025 may be encoded in a platform native binary, any interpreted language such as Java™ byte-code, or in any other language such as C/C++, the Java™ programming language, etc., or in any combination thereof, to implement various applications such as a machine learning system 2026. In various embodiments, applications, operating systems, and/or shared libraries may each be implemented in any of various programming languages or methods. For example, in one embodiment, operating system may be based on the Java™ programming language, while in other embodiments it may be written using the C or C++ programming languages. Similarly, applications may be written using the Java™ programming language, C, C++, or another programming language, according to various embodiments. Moreover, in some embodiments, applications, operating system, and/shared libraries may not be implemented using the same programming language. For example, applications may be C++ based, while shared libraries may be developed using C.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A computer-implemented method, comprising:
identifying a differentially-private subnetwork of a neural network, comprising:
computing respective differentially-private score values for individual ones of a plurality of weighting parameters of the neural network according to training data for the differentially-private subnetwork; and
selecting a portion of the plurality of weighting parameters having highest respective differentially-private score values to identify the differentially-private subnetwork, wherein the selected portion excludes at least one lowest scored weighting parameter of the plurality of weighting parameters.

2. The computer-implemented method of claim 1, further comprising randomly initializing the plurality of weighting parameters of the neural network with differing values prior to computing the respective scores for the individual ones of the plurality of weighting parameters.

3. The computer-implemented method of claim 2, wherein the plurality of weighting parameters of the neural network are randomly initialized according to a normal distribution.

4. The computer-implemented method of claim 1, wherein respective weighting parameters of the neural network excluded from the selected portion are set to a zero value in the differentially-private subnetwork.

5. The computer-implemented method of claim 1, wherein computing respective differentially-private score values comprises executing one or more iterations of a scoring computation, and wherein an iteration of the one or more iterations comprises:
computing respective score values for the individual ones of the plurality of weighting parameters of the neural network according to samples of the training data for the differentially-private subnetwork;
adding respective noise values to the respective computed score values to generate respective differentially-private score values;
selecting the portion of the plurality of weighting parameters having the highest respective differentially-private score values to identify the differentially-private subnetwork, wherein the selected portion excludes at least one lowest scored weighting parameter of the plurality of weighting parameters; and
updating the respective computed score values according to the identified differentially-private subnetwork using a stochastic gradient descent technique.

6. The computer-implemented method of claim 1, wherein computing respective differentially-private score values comprises executing one or more iterations of a scoring computation, wherein an iteration of the one or more iterations comprises:
computing the respective differentially-private score values for the individual ones of the plurality of weighting parameters of the neural network according to samples of the training data for the differentially-private subnetwork;
selecting the portion of the plurality of weighting parameters having the highest respective differentially-private score values to identify the differentially-private subnetwork, wherein the selected portion excludes at least one lowest scored weighting parameter of the plurality of weighting parameters; and
updating the respective computed score values according to the identified differentially-private subnetwork using a differentially-private stochastic gradient descent technique.

7. The computer-implemented method of claim 1, wherein the portion of the plurality of weighting parameters comprises a variable number of weighting parameters, the variable number determined according to a minimum accuracy threshold.

8. One or more non-transitory computer-accessible storage media storing program instructions that when executed on or across one or more computing devices cause the one or more computing devices to implement:
identifying a differentially-private subnetwork of a neural network, comprising:
computing respective differentially-private score values for individual ones of a plurality of weighting parameters of the neural network according to training data for the differentially-private subnetwork; and
selecting a portion of the plurality of weighting parameters having highest respective differentially-private score values to identify the differentially-private subnetwork, wherein the selected portion excludes at least one lowest scored weighting parameter of the plurality of weighting parameters.

9. The one or more non-transitory computer-accessible storage media of claim 8, further comprising randomly initializing the plurality of weighting parameters of the neural network with differing values prior to computing the respective scores for the individual ones of the plurality of weighting parameters.

10. The one or more non-transitory computer-accessible storage media of claim 8, wherein the plurality of weighting parameters of the neural network are randomly initialized according to a kaiming normal distribution.

11. The one or more non-transitory computer-accessible storage media of claim 8, wherein respective weighting parameters of the neural network excluded from the selected portion are set to a zero value in the differentially-private subnetwork.

12. The one or more non-transitory computer-accessible storage media of claim 8, wherein computing respective differentially-private score values comprises executing one or more iterations of a scoring computation, wherein an iteration of the one or more iterations comprises:
computing respective score values for the individual ones of the plurality of weighting parameters of the neural network according to samples of the training data for the differentially-private subnetwork;
adding respective noise values to the respective computed score values to generate respective differentially-private score values;
selecting the portion of the plurality of weighting parameters having the highest respective differentially-private score values to identify the differentially-private subnetwork, wherein the selected portion excludes at least one lowest scored weighting parameter of the plurality of weighting parameters; and
updating the respective computed score values according to the identified differentially-private subnetwork using a stochastic gradient descent technique.

13. The one or more non-transitory computer-accessible storage media of claim 8, wherein computing respective differentially-private score values comprises executing one or more iterations of a scoring computation, and wherein an iteration of the one or more iterations comprises:
computing the respective differentially-private score values for the individual ones of the plurality of weighting parameters of the neural network according to samples of the training data for the differentially-private subnetwork;
selecting the portion of the plurality of weighting parameters having the highest respective differentially-private score values to identify the differentially-private subnetwork, wherein the selected portion excludes at least one lowest scored weighting parameter of the plurality of weighting parameters; and
updating the respective computed score values according to the identified differentially-private subnetwork using a differentially-private stochastic gradient descent technique.

14. The one or more non-transitory computer-accessible storage media of claim 8, wherein the portion of the plurality of weighting parameters comprises a variable number of weighting parameters, the variable number determined according to a minimum accuracy threshold.

15. A system, comprising:
one or more processors; and
a memory storing program instructions that when executed by the one or more processors cause the one or more processors to implement a differentially-private machine learning system, configured to:
identify a differentially-private subnetwork of a neural network, wherein to identify the differentially-private subnetwork the differentially-private machine learning system is configured to:
compute respective differentially-private score values for individual ones of a plurality of weighting parameters of the neural network according to training data for the differentially-private subnetwork; and
select a portion of the plurality of weighting parameters having highest respective differentially-private score values to identify the differentially-private subnetwork, wherein the selected portion excludes at least one lowest scored weighting parameter of the plurality of weighting parameters.

16. The system of claim 15, wherein the differentially-private machine learning system is further configured to randomly initialize the plurality of weighting parameters of the neural network with differing values prior to computing the respective scores for the individual ones of the plurality of weighting parameters.

17. The system of claim 15, wherein the plurality of weighting parameters of the neural network are randomly initialized according to a xavier normal distribution.

18. The system of claim 15, wherein respective weighting parameters of the neural network excluded from the selected portion are set to a zero value in the differentially-private subnetwork.

19. The system of claim 15, wherein to compute respective differentially-private score values the differentially-private machine learning system is configured to execute one or more iterations of a scoring computation, and wherein to execute one an iteration of the one or more iterations the differentially-private machine learning system is configured to:
compute respective score values for the individual ones of the plurality of weighting parameters of the neural network according to samples of the training data for the differentially-private subnetwork;
add respective noise values to the respective computed score values to generate respective differentially-private score values;
select the portion of the plurality of weighting parameters having the highest respective differentially-private score values to identify the differentially-private subnetwork, wherein the selected portion excludes at least one lowest scored weighting parameter of the plurality of weighting parameters; and
update the respective computed score values according to the identified differentially-private subnetwork using a stochastic gradient descent technique.

20. The system of claim 15, wherein to compute respective differentially-private score values the differentially-private machine learning system is configured to execute one or more iterations of a scoring computation, wherein to execute one an iteration of the one or more iterations the differentially-private machine learning system is configured to:
compute the respective differentially-private score values for the individual ones of the plurality of weighting parameters of the neural network according to samples of the training data for the differentially-private subnetwork;
select the portion of the plurality of weighting parameters having the highest respective differentially-private score values to identify the differentially-private subnetwork, wherein the selected portion excludes at least one lowest scored weighting parameter of the plurality of weighting parameters; and
update the respective computed score values according to the identified differentially-private subnetwork using a differentially-private stochastic gradient descent technique.
